(19) United States
(12) Patent Application Publication
(10) Pub. No.: US 2007/0181399 A1
(43) Pub. Date: Aug. 9, 2007

(54) WRAP SPRING CLUTCH

(75) Inventors: Juergen ACKERMANN, Waal (DE); Falk NICKEL, Fuchstal (DE)

Correspondence Address: SHERIDAN ROSS PC, 1560 BROADWAY, SUITE 1200, DENVER, CO, 80202, US

(73) Assignee: HOERBIGER ANTRIEBSTECHNIK GMBH, Schongau (DE)

(21) Appl. No.: 11/670,575

(22) Filed: Feb. 2, 2007

(30) Foreign Application Priority Data
Feb. 2, 2006 (EP) 06002156.5

(51) Int. Cl. F16D 13/08

(52) U.S. Cl. 192/81 C; 192/41 S

(57) ABSTRACT

The present invention relates to a wrap spring clutch comprising a first shaft; a wrap spring wound around the first shaft in a winding direction and comprising wrap spring ends; and comprising a second hollow shaft arranged around the wrap spring to be concentric to the first shaft, characterized by an actuator for applying a controlled tangential force onto at least one of the wrap spring ends in a direction opposite to the winding direction of the wrap spring.

### CROSS REFERENCE TO RELATED APPLICATION

This application claims the benefit of European Patent Application No. 06002156.5, filed on Feb. 2, 2006, the entire disclosure of which is hereby incorporated herein by reference.

### DESCRIPTION

The present invention relates to a wrap spring clutch according to the preamble of claim 1.

In the automation and electronic control of drives for engines and automotive vehicles, clutches with appropriate properties have gained more and more importance. The core demands are high torque variability, short reaction time, small constructional space, small efforts and power consumption of the clutch actuator, high reliability and a behavior that is as constant as possible over the whole service life cycle. Nowadays multi-plate clutches with different actuator systems are predominantly used. These may be of an electrical, electrohydraulic, pneumatic, mechanical or MRF/ERF type. In the known systems, the expenditure is high with an increasing torque demand both for the transmitting part and the actuator system. The integration of the system becomes more and more difficult and the costs for it are rising.

A generally known wrap spring clutch corresponding to the preamble of claim 1 has only been used as a passive element up to the present day, e.g. as a torque limiter, or as an active element in designs that, however, only have an on/off function.

It is therefore the object of the present invention to provide a wrap spring clutch of the type specified in the preamble of claim 1, which permits a controllable torque transmission and can thus be used e.g. in automated controlled drive trains, above all in drive trains of automotive vehicles, as an active component.

This object is achieved by the features of claim 1.

Counted among the special advantages of the wrap spring clutch according to the invention in comparison with the formerly known active clutch systems are first of all the accomplishment of a low drag moment as well as low weight and inertia. Furthermore, the wrap spring clutch according to the invention only requires a small constructional space and shows low power consumption, which can e.g. be satisfied by a normal onboard power supply in an automotive vehicle.

Furthermore, the wrap spring clutch according to the invention hardly fails due to the low complexity of the system, it does not require any additional units and is characterized by low manufacturing and maintenance costs.

The subclaims refer to advantageous developments of the invention.

Further details, advantages and features of the present invention will become apparent from the following description of an embodiment with reference to the drawing, in which

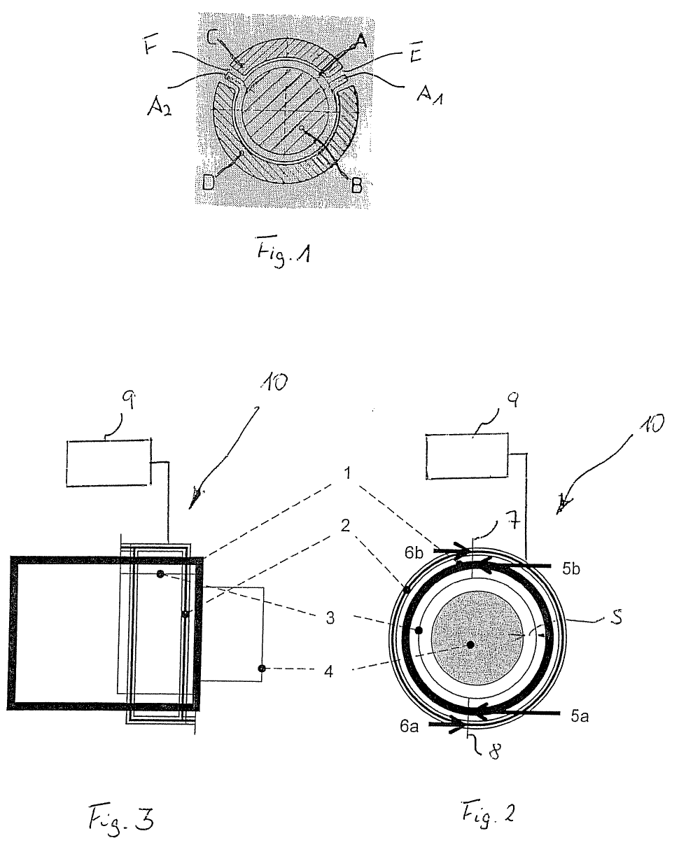

FIG. 1 is a front view of the general construction of a wrap spring clutch, which is very simplified schematically;

FIG. 2 is a front view of a wrap spring clutch according to the invention, which is very simplified schematically; and

FIG. 3 is a side view of the wrap spring clutch according to FIG. 2, which is also very simplified schematically.

### LIST OF REFERENCE NUMERALS

1 second hollow shaft
2 actuator
3 wrap spring
4 first shaft
5A, 5B force arrows
6A, 6B force arrows
7, 8 wrap spring ends
9 control means
10 wrap spring clutch
A wrap spring
B fixed shaft
A1, A2 spring ends
C, D segments

For the explanation of a generally possible construction of a wrap spring clutch, FIG. 1 shows a wrap spring A which is arranged with a bias on a fixed shaft B. Depending on the direction of rotation, a segment C of a drive member acts on the two spring ends A1 and A2 projecting in or through recesses E and F. In case of a load on the output a segment D is co-rotated by form closure via the respective spring end A1 or A2. If a drive-overrunning torque is about to be generated on the output, segment D will perform a blocking action via the respective spring element A1 or A2 of the wrap spring A.

This system involves a minimum clearance between the flanks of the segments C and D and the spring ends A1 and A2 and is independent of the direction of rotation. The winding direction of the wrap spring A has also no influence on the function.

Instead of a fixed shaft B, a corresponding construction may be provided in a sleeve (not shown in more detail in FIG. 1) in a housing. The ends A1 and A2 of the wrap spring A are then bent inwards accordingly.

The wrap spring clutch 10 shown in FIGS. 2 and 3 has a first shaft 4 surrounded by a wrap spring 3, the wrap spring 3 being wound in a defined winding direction around the first shaft 4, and two wrap spring ends 6 and 7 radially extending in the exemplary case in opposite direction.

Furthermore, the wrap spring clutch 10 comprises a second hollow shaft 1 which is arranged around the wrap spring 3 to be concentric to the first shaft 4. In the illustrated embodiment, this second shaft 1 has a recess, which is not shown in more detail in the drawing because of the schematic simplification, so that the second shaft 1 can only abut in the winding direction of the wrap spring 3 on the radial wrap spring ends 7 and 8.

Furthermore, the wrap spring clutch 10 according to the invention comprises an actuator 2 which for the application of a controlled tangential force is provided on at least one of the wrap spring ends 7 and 8, respectively, in a direction opposite to the winding direction of the wrap spring 3. The provision of this actuator 2 and its action on the wrap spring end(s) (7) and/or (8) in a direction opposite to the winding direction make the torque transmission of the inventive wrap spring clutch 10 controllable because in contrast to the formerly known wrap spring clutches with a mere on/off function the controllability of the application of the tangential force also accomplishes intermediate states in which the wrap spring 3 permits slip in a targeted way, whereby a control of the torque to be transmitted is made possible.

To this end the contact surfaces of the wrap spring 3 and of the first shaft 4 may selectively be provided without a coating or with the same coating or with a different coating. These coatings can preferably consist of paper, carbon, sintering materials or molybdenum.

Furthermore, the frictional surfaces may be running against one another in a dry condition or in a fluid, preferably oil.

As has already been explained before, the second shaft 1 can be communicated via the wrap spring 3 with the first shaft 4 through a controllable torque.

The actuator 2 which is arranged above the second shaft 1 may e.g. be configured in the form of an electric servo motor. Preferably, the actuator 2 can exert a controlled force in tangential direction in one embodiment of the inventive wrap spring clutch with one direction of rotation on the corresponding wrap spring end 7 or 8. In an embodiment with a selectable direction of rotation, which is also feasible, the actuator can load the corresponding wrap spring end 7 or 8 with a controlled force.

The function of the wrap spring clutch 10 according to the invention is as follows:

A torque is introduced via shaft 4. Depending on the direction of rotation, the shaft 1 gets into contact with a surface of the recess on one of the two wrap spring ends 7 or 8, and a force is built up that is marked in FIG. 2 with arrows 5A and 5B, respectively. The wrap spring 3 is tightened by this force. In this process the wrap spring 3 gets on its inner diameter into contact with the shaft 4. The frictional force between the shaft 4 and the wrap spring 3 yields the transmitted torque and at the same time it accomplishes a pressing of the wrap spring 3 increasing with the transmitted torque, with a correspondingly increasing frictional force. Without use of the actuator 2 the torque adapts by self-amplification to the maximum torque of the wrap spring clutch 10.

As a rule, the following configurations of the inventive wrap spring clutch 10 are feasible:

The actuator 2 can rotate with the shaft 1. The torque is controlled with the actuator 2 by the measure that the actuator acts on the free wrap spring end 7 or 8 with a controlled force (arrows 6A and 6B, respectively, in FIG. 2). The wrap spring 3 is thereby unloaded and the transmittable torque is reduced. The determination of the actuating force and thus the transmittable torque may be given as a fixed manipulated variable.

Preferably, the actuator 2 is integrated into a control system which is symbolized in FIGS. 2 and 3 by block 9. The torque is then directly or indirectly predetermined in dependence upon suitable parameters, e.g. the wheel slip or the throttle valve position in automotive vehicles, directly or indirectly.

A second feasible embodiment of the wrap spring clutch 10 of the invention corresponds in its basic function to the previously explained first embodiment. In this embodiment the actuator 2 is fixed to a housing (not shown in more detail in FIGS. 2 and 3). The torque is controlled with the actuator 2 in that said actuator acts on the respectively free wrap spring ends 7 and 8, respectively, with a controlled force 6A and 6B, respectively. The wrap spring 3 is thereby unloaded and the transmittable torque is reduced. To this end a pressure element of the actuator 2, which is not shown in more detail in FIGS. 2 and 3, is possibly made to follow the corresponding wrap spring end 7 and 8, respectively. Depending on the requirement, the speed can ideally be controlled thereby also directly.

In a third feasible embodiment of the wrap spring clutch 10 of the invention, the basic function corresponds again to the embodiments 1 and 2. In this embodiment, however, the actuator 2 may be integrated into the shaft 4. In this embodiment the torque is also controlled with the actuator 2 in that said actuator acts again on the respectively free wrap spring end 7 and 8, respectively, with the controlled force 6A and 6B, respectively. In this embodiment the wrap spring 3 is also unloaded and the transmittable torque is reduced. The pressure element of the actuator 2, which is also provided in this embodiment, is optionally made to follow the corresponding wrap spring end 7 and 8, respectively. Hence, in this embodiment, too, depending on the requirement, the rotational speed difference with respect to the engine, preferably the combustion engine, can ideally be controlled also directly.

1. A wrap spring clutch comprising
a first shaft;
a wrap spring wound around the first shaft in a winding direction and comprising two wrap spring ends; and
a second hollow shaft arranged around the wrap spring to be concentric to the first shaft; and
an actuator for applying a controlled tangential force onto at least one of the wrap spring ends in a direction opposite to the winding direction of the wrap spring.

2. The wrap spring clutch according to claim 1, further comprising a control means that controls the actuator in dependence upon suitable parameters.

3. The wrap spring clutch according to claim 1, wherein the contact surfaces between the wrap spring and the first shaft are provided with a coating of the same or different materials.

4. The wrap spring clutch according to claim 3, wherein the coating material is paper, carbon, sinter or molybdenum.

5. The wrap spring clutch according to claim 3, wherein the contact surfaces are engaged in at least one of a dry condition and a fluid condition.

6. The wrap spring clutch according to claim 1, wherein the actuator is at least one of an electric servo motor, a pneumatic device, a hydraulic device, a piezo device, and a magnet device.

7. The wrap spring clutch according to claim 1, wherein the second hollow shaft comprises a recess in such a way that the second shaft can only abut in the winding direction of the the wrap spring on wrap spring ends radially extending in opposite directions.

8. The wrap spring clutch according to claim 1, wherein the actuator is supported either on one of the two shafts or on a fixed housing part.

9. The wrap spring clutch according to claim 1, wherein the actuator is arranged on a clutch housing.

10. The wrap spring clutch according to claim 1, wherein the actuator is integrated into the first shaft.
